(19) United States
(12) Patent Application Publication
(10) Pub. No.: US 2024/0135847 A1
(43) Pub. Date: Apr. 25, 2024

(54) DISPLAY PANEL AND ELECTRONIC DEVICE

(71) Applicant: Wuhan China Star Optoelectronics Semiconductor Display Technology CO., Ltd, Wuhan (CN)

(72) Inventor: Jian YE, Wuhan (CN)

(21) Appl. No.: 17/284,456

(22) PCT Filed: Dec. 31, 2020
(86) PCT No.: PCT/CN2020/142495

§ 371 Date: Apr. 9, 2021

(30) Foreign Application Priority Data
Dec. 30, 2020 (CN) 202011598413.6

(51) Int. Cl. G09G 3/20

(52) U.S. Cl. CPC G09G 3/20; G09G 2320/0233; G09G 2320/0247

(57) ABSTRACT

A display panel and an electronic device are provided. The display panel includes a plurality of pixels, a plurality of pixel driving circuits, a gate on array (GOA) circuit, and an IC chip. A corresponding number of display pulses is provided to the corresponding pixel driving circuit for different refresh frequencies in each display driving cycle so that display durations can be same or similar when displaying at different refresh frequencies. This reduces or eliminates brightness difference or flicker that occurs when refresh frequencies are switched.

### FIELD OF INVENTION

This application relates to the field of display technology and in particular to a display panel and an electronic device.

### BACKGROUND OF INVENTION

Currently, on the market, display screens need to display at different refresh frequencies based on different application scenarios of terminals. For example, ordinary images are displayed at a refresh frequency of 60 Hz, game modes are displayed at a refresh frequency of 120 Hz or higher, and some other application scenarios need to be displayed at 90 Hz or other refresh frequencies.

At different refresh frequencies, display duration of one frame is also different. During a display process, switching a refresh frequency requires switching gate on array (GOA) timing, etc., which results in different writing times and light-emitting times of data signals (Data), which further causes a visible screen flicker.

### Technical Problem

The present application provides a display panel and an electronic device, which alleviate the problem of screen flicker caused by switching of refresh frequencies.

### SUMMARY OF INVENTION

In a first aspect, the present application provides a display panel, which includes a plurality of pixels, a plurality of pixel driving circuits, a gate on array (GOA) circuit, and an IC chip. Each pixel driving circuit is electrically connected to a corresponding one of pixels. The GOA circuit is electrically connected to a pixel driving circuit and is configured to provide the pixel driving circuit with a corresponding number of display pulses in each display driving cycle. The IC chip is electrically connected to the GOA circuit and is configured to control the GOA circuit to change a number of the display pulses output during the display driving cycle according to a first frequency switching signal. In a second aspect, the present application provides an electronic device, which includes the display panel in any of the embodiments.

The display panel and the electronic device provided by the present application provide a corresponding number of display pulses to the corresponding pixel driving circuits for different refresh frequencies in each display driving cycle so that displaying at different refresh frequencies with the same or similar display duration can be achieved. Furthermore, it can have the same or similar display brightness, which reduces or eliminates the brightness difference or flicker phenomenon that occurs when the refresh frequency is switched. In addition, only the number of the display pulses is changed, so there is no need to switch the GOA time sequence, and it will not cause the write time of the data signal to change.

### DESCRIPTION OF DRAWINGS

In order to more clearly illustrate the technical solutions in the embodiments of the present invention, the following figures described in the embodiments will be briefly introduced. It is obvious that the drawings described below are merely some embodiments of the present invention, other drawings can also be obtained by the person ordinary skilled in the field based on these drawings without doing any creative activity.

FIG. 1 is a schematic structural diagram of a display panel provided by an embodiment of the present application.

FIG. 2 is a schematic flowchart of a display driving method provided by an embodiment of the present application.

FIG. 3 is a schematic diagram of a first time sequence of display driving provided by an embodiment of the present application.

FIG. 4 is a schematic diagram of a second time sequence of display driving provided by an embodiment of the present application.

### DETAILED DESCRIPTION OF PREFERRED EMBODIMENTS

In order to make the purpose, technical solutions, and effects of this application clear, the following further describes this application in detail with reference to the drawings and embodiments. It should be understood that the specific embodiments described herein are only used to explain the application, but not used to limit the application.

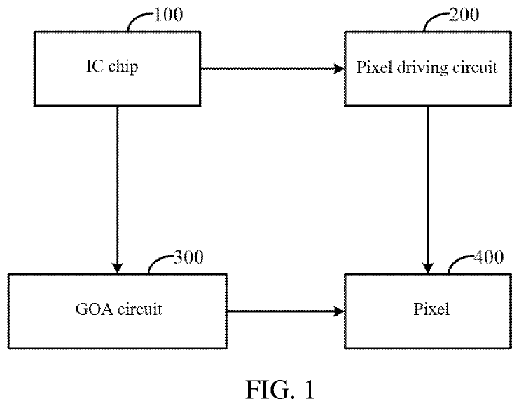

Please refer to FIG. 1 to FIG. 4. As shown in FIG. 1, this embodiment provides a display panel including a plurality of pixels 400, a plurality of pixel driving circuits 200, a gate on array (GOA) circuit 300, and an IC chip 100. Each pixel driving circuit 200 is electrically connected to a corresponding pixel 400. The GOA circuit 300 is electrically connected to the pixel driving circuit 200 and is configured to provide the pixel driving circuit 200 with a corresponding number of display pulses in each display driving cycle. The IC chip 100 is electrically connected to the GOA circuit 300 for controlling the GOA circuit 300 to change the number of the display pulses output during the display driving cycle according to the first frequency switching signal.

Specifically, the IC chip 100 is connected to the pixel driving circuit 200 and the GOA circuit 300, and the pixel 400 is connected to the pixel driving circuit 200 and the GOA circuit 300. The display panel can respond to at least two refresh frequencies, for example, the first refresh frequency and the second refresh frequency, where the first refresh frequency is greater than the second refresh frequency, the first refresh frequency is the highest refresh frequency that the display panel can provide, and the second refresh frequency can be customized according to customers' requirements. Wherein, the display panel can be freely switched between the first refresh frequency and the second refresh frequency in response to the request of the application end for the refresh frequency. Wherein, the GOA circuit 300 is electrically connected to the pixel driving circuit 200 and is configured to provide the pixel driving circuit 200 with a corresponding number of display pulses in each display driving cycle. The IC chip 100 is electrically connected to the GOA circuit 300 for controlling the GOA circuit 300 to change the number of the display pulses output in the display driving cycle according to the first frequency switching signal. In this embodiment, the IC chip 100 is a chip integrating a timing controller and a source driver, which has a higher degree of integration and occupies a smaller space.

In this embodiment, the GOA circuit 300 is a light-emitting control GOA circuit or an EM GOA circuit, which is configured to control the number of the display pulses of the pixels in the corresponding display driving cycle.

In one embodiment, the display panel is provided with at least a first refresh frequency and a second refresh frequency, and the first refresh frequency is greater than the second refresh frequency. An IC chip 100 is configured to control the GOA circuit 300 to increase the number of the display pulses output during the display driving cycle when the display panel is switched from the first refresh frequency to the second refresh frequency. Alternatively, the IC chip 100 is configured to control the GOA circuit 300 to reduce the number of display pulses output during the display driving cycle when the display panel is switched from the second refresh frequency to the first refresh frequency.

In one embodiment, each display driving cycle includes an effective display period and an ineffective display period. The pixel driving circuit 200 is configured to drive the corresponding pixel 400 to display an image according to the display pulse received during the effective display period. Wherein, the IC chip is configured to control the GOA circuit to provide the display pulses with a difference between a number of the display pulses during the effective display period of the display driving cycles corresponding to the first refresh frequency and a number of the display pulses provided during the effective display period of the display driving cycles corresponding to the second refresh frequency to be less than or equal to a preset threshold.

Wherein, the preset threshold can be, but is not limited to, greater than or equal to zero and less than or equal to 9. For example, it can be 1, 2, or 3, etc. Specifically, the IC chip 100 controls the number of the display pulses provided by the GOA circuit 300 during the effective display period of the display driving cycles corresponding to the first refresh frequency and the number of the display pulses provided by the GOA circuit 300 during the effective display period of the display driving cycles corresponding to the second refresh frequency to be same.

In one embodiment, the IC chip 100 is configured to control the GOA circuit 300 to provide a number of display pulses during the ineffective display period of the display driving cycles corresponding to the first refresh frequency to be greater than a number of the display pulses provided during the ineffective display period of the display driving cycles corresponding to the second refresh frequency.

In one embodiment, based on the following formula:

1/F1*1/N1=1/F2*1/(N1+X1), the IC chip 100 controls the number of the display pulses provided by the GOA circuit 300 during the effective display period of the display driving cycles corresponding to the first refresh frequency and the number of the display pulses provided by the GOA circuit 300 during the effective display period to be same.

Wherein, F1 is the first refresh frequency, F2 is the second refresh frequency, N1 is the number of the display pulses provided during the effective display period of the display driving cycles corresponding to the first refresh frequency, and X1 is the number of the display pulses provided in the ineffective display period of the display driving cycles corresponding to the second refresh frequency, wherein N1 and X1 are both positive integers.

In one embodiment, the display panel is further provided with a third refresh frequency, the first refresh frequency is greater than the third refresh frequency, and the second refresh frequency is different from the third refresh frequency. The IC chip 100 is configured to control the GOA circuit 300 to increase the number of the display pulses output in the display driving cycles when the display panel is switched from the first refresh frequency to the third refresh frequency; alternatively, the IC chip 100 is configured to control the GOA circuit 300 to reduce the number of the display pulses output in the display driving cycles when the display panel is switched from the third refresh frequency to the first refresh frequency.

In one embodiment, each of the display driving cycles includes an effective display period and an ineffective display period, wherein the IC chip 100 controls the number of the display pulses provided by the GOA circuit 300 during the effective display period of the display driving cycles corresponding to the first refresh frequency, the number of the display pulses provided during the effective display period of the display driving cycles corresponding to the second refresh frequency, and a number of display pulses provided during the effective display period of the display driving cycles corresponding to the third refresh frequency to be same.

In one embodiment, according to the following formula: 1/F1*1/N1=1/F2*1/(N1+X1)=1/F3*1/(N1+X2), the IC chip 100 controls the number of the display pulses provided by the GOA circuit 300 during the effective display period of the display driving cycles corresponding to the first refresh frequency, the number of the display pulses provided during the effective display period of the display driving cycles corresponding to the second refresh frequency, and the number of the display pulses provided during the effective display period of the display driving cycles corresponding to the third refresh frequency to be same.

Wherein F1 is the first refresh frequency, F2 is the second refresh frequency, F3 is the third refresh frequency, N1 is the number of the display pulses provided during the effective display period of the display driving cycles corresponding to the first refresh frequency, X1 is a number of the display pulses provided in the ineffective display period of the display driving cycles corresponding to the second refresh frequency, and X2 is a number of the display pulses provided in the ineffective display period of the display driving cycles corresponding to the third refresh frequency, and wherein N1, X1, and X2 are all positive integers.

In one embodiment, the effective display period can be, but is not limited to, a vertical effective display cycle, and the ineffective display period can be, but is not limited to, a vertical blanking cycle.

In one embodiment, the display driving period includes a vertical effective display cycle and a vertical blanking cycle. In response to the first refresh frequency, the vertical effective display cycle corresponding to one frame is configured as the first vertical effective display cycle. In response to the second refresh frequency, the vertical effective display cycle and the vertical blanking cycle corresponding to one frame are configured as the corresponding second vertical effective display cycle and the second vertical blanking cycle. The first vertical effective display cycle is same as the second vertical effective display cycle.

It should be noted that the first vertical effective display cycle is same as the second vertical effective display cycle, and it can be determined that when switching between different refresh frequencies, the corresponding frame has same effective display time.

In one embodiment, according to the first refresh frequency and the second refresh frequency, the GOA circuit outputs a first number of the display pulses during the first vertical effective display cycle or the second vertical effective display cycle.

It should be noted that, in response to different refresh frequencies, each frame has the same effective display time and the same number of display pulses. It illustrates that no matter how the refresh frequency is switched, each corresponding frame has the same display time and corresponds to the same display brightness. This eliminates the flicker phenomenon that is likely to occur at different refresh frequencies.

In one embodiment, according to the first number and the second refresh frequency, in the second vertical blanking cycle, the GOA circuit outputs a second number of display pulses.

Specifically, in one embodiment, the cycle of the display pulse is a result of dividing the first vertical effective display cycle or the second vertical effective display cycle by the first number. The number of display pulses during the display driving cycle corresponding to the second refresh frequency is a result of dividing a reciprocal of the second refresh frequency by the cycle of display pulse. The second initial number is a difference between the number of the display pulses during the display driving cycle corresponding to the second refresh frequency and the first initial number. The second number is a second integer multiple of the second initial number, and a first integer multiple is same as the second integer multiple.

In one embodiment, the second vertical blanking cycle is determined according to the first number, the second number, and the second refresh frequency.

Specifically, in one embodiment, the second vertical blanking cycle is a multiplication of the cycle of the display pulse and the second number.

In one embodiment, the display panel is further provided with a third refresh frequency, and the first refresh frequency is greater than the third refresh frequency. In response to the second frequency switching signal, the display panel switches between the third refresh frequency and the first refresh frequency or the second refresh frequency.

In one embodiment, in response to the third refresh frequency, the vertical effective display cycle and the vertical blanking cycle corresponding to one frame are configured as the corresponding third vertical effective display cycle and the third vertical blanking cycle. The first vertical effective display cycle is same as the third vertical effective display cycle.

In one embodiment, the GOA circuit outputs a second number of display pulses during any of the first vertical effective display cycle, the second vertical effective display cycle, or the third vertical effective display cycle according to the first refresh frequency, the second refresh frequency, or the third refresh frequency, respectively.

Wherein, the IC chip 100 is configured to control the GOA circuit 300 to output a corresponding light-emitting control signal according to the first refresh frequency or the second refresh frequency. The light-emitting control signal can control the corresponding pixel driving circuit 200 to output a corresponding number of display pulses, thereby controlling the display time of any display frame. The IC chip 100 is also configured to generate a corresponding data transmission synchronization signal according to the first refresh frequency or the second refresh frequency. The data transmission synchronization signal is used to indicate the vertical effective display cycle and vertical blanking cycle of any display frame.

Wherein, the data transmission synchronization signal can be, but is not limited to, a square wave signal. When the square wave signal is at a low potential, it is used to limit or define a vertical effective display cycle, and when the square wave signal is at a high potential, it is used to limit or define a vertical blanking cycle. Similarly, the data transmission synchronization signal can also adopt a high potential to limit or define a vertical effective display cycle and adopt a low potential to limit or define a vertical blanking cycle.

Wherein, the vertical blanking cycle can include at least one of a front porch or a back porch of the data transmission synchronization signal.

It can be understood that in the vertical effective display cycle, the number of the display pulses corresponds to the display time of a display frame. In particular, if the display time is the same or similar, the number of the display pulses in the corresponding vertical effective display cycle is equal or approximately equal in different display frames.

Based on this, according to the customer's requirements for the refresh frequency of the display panel, the specific values of the first refresh frequency and the second refresh frequency can be obtained. For example, the first refresh frequency can be, but is not limited to 120 Hz, and the second refresh frequency can be, but is not limited to 60 Hz. According to specific values of the first refresh frequency and the second refresh frequency, the duration of one display frame can be correspondingly determined. It should be noted that the duration correspondingly includes the vertical effective display cycle and the vertical blanking cycle. For example, the duration corresponding to the first refresh frequency of 120 Hz is 8.33 ms, and the duration corresponding to the second refresh frequency of 60 Hz is 16.7 ms.

Because the first refresh frequency is the highest refresh frequency that can be provided by the display panel, the vertical blanking cycle could be very short and could even be zero. Its first vertical effective display cycle is close to the duration of the entire frame. Based on this, it can be determined that the first vertical effective display cycle corresponding to the first refresh frequency can be the display time. Then, the first vertical effective display cycle corresponding to the first refresh frequency is configured as the second vertical effective display cycle corresponding to the second refresh frequency. That is, the first vertical effective display cycle and the second vertical effective display cycle corresponding to the first refresh frequency and the second refresh frequency, respectively, are same.

Based on this, it is possible to determine a first target number of the corresponding light-emitting cycle in the first vertical effective display cycle when displaying at the first refresh frequency. Further, the second target number of the light-emitting cycle of the second vertical effective display cycle corresponding to the second refresh frequency is configured to be the same value as the first target number. Therefore, it can be determined that when the display panel is displayed at different refresh frequencies, it can have same first vertical effective display cycle and second vertical effective display cycle, i.e., the same display time, and have same or similar display brightness. This can eliminate or reduce the brightness difference (i.e., screen flicker) when switching between different refresh frequencies.

Further, according to a result of dividing the first vertical effective display cycle by the first target number, the duration of the light-emitting cycle can be obtained. According to the second refresh frequency, a sum of the vertical blanking cycle and the second vertical effective display cycle can be obtained. According to a result of dividing the sum of the vertical blanking cycle and the second vertical effective display cycle by the duration of the light-emitting cycle, the number to be configured can be obtained.

Further, the third target number can be obtained according to the difference between the number to be configured and the second target number.

Further, the vertical blanking cycle corresponding to the second refresh frequency can be obtained according to the third target number. Wherein, the third target number is the number of corresponding light-emitting cycles in the vertical blanking cycle.

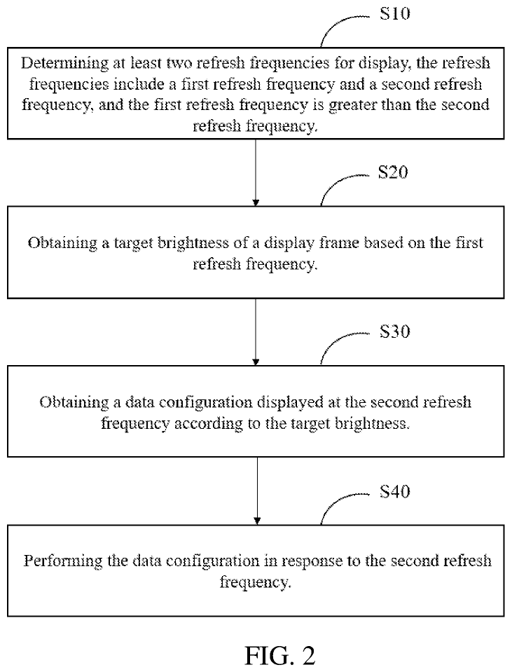

As shown in FIG. 2, in one embodiment, the present application provides a display driving method, which includes following steps:

Step S10: Determining at least two refresh frequencies for display, the refresh frequencies include a first refresh frequency and a second refresh frequency, and the first refresh frequency is greater than the second refresh frequency.

Step S20: Obtaining a target brightness of a display frame based on the first refresh frequency.

Specifically, based on the first refresh frequency, the first vertical effective display cycle of the display frame can be determined. Wherein, the first refresh frequency is F1, the second refresh frequency is F2, the initial number is N, and the number to be increased is X, wherein N and X are both positive integers.

Based on the first refresh frequency, the second refresh frequency, the initial number, and the number to be increased, a formula is established as follows:

F1*N=F2*(N+X)

Based on the formula, the number to be increased is the smallest positive integer.

Determining the initial number according to the formula and the number to be increased.

According to the first refresh frequency and the second refresh frequency, the first target number of corresponding light-emitting cycles in the first vertical effective display cycle can be obtained.

Specifically, based on the first refresh frequency and the second refresh frequency, the initial number of the corresponding light-emitting cycles in the first vertical effective display cycle is determined. Based on an integer multiple of the initial number, the first target number can be determined. Based on the first target number and the first vertical effective display cycle, the target brightness can be determined.

Step S30: Obtaining a data configuration displayed at the second refresh frequency according to the target brightness.

Specifically, based on the first refresh frequency and the second refresh frequency, the vertical blanking cycle corresponding to the second refresh frequency and the second vertical effective display cycle can be determined. According to the first refresh frequency, the second refresh frequency, and the first target number, the number to be configured corresponding to the second refresh frequency can be determined, and the number to be configured is the number of the corresponding light emitting periods in the vertical blanking cycle and the second vertical effective display cycle.

Specifically, according to a result of dividing the first vertical effective display cycle by the first target number, the duration of the light-emitting cycle can be obtained.

According to the second refresh frequency, a sum of the vertical blanking cycle and the second vertical effective display cycle can be obtained.

According to a result of dividing the sum of the vertical blanking cycle and the second vertical effective display cycle by the duration of the light-emitting cycle, the number to be configured can be obtained.

Based on the first target number and the number to be configured, the second target number of the corresponding light-emitting cycle in the second vertical effective display cycle and the third target number of the corresponding light-emitting cycle in the vertical blanking cycle can be determined.

Specifically, based on the target brightness and the first target number, the second target number is configured to be the same value as the first target number.

The third target quantity is determined according to the difference between the number to be configured and the second target number.

When displaying at the first refresh frequency or the second refresh frequency, the same first vertical effective display cycle and the same second vertical effective display cycle are configured.

According to the third target number, the vertical blanking cycle can be obtained.

Step S40: Performing the data configuration in response to the second refresh frequency.

In one embodiment, the light-emitting cycle corresponds to the frequency of the light-emitting control signal in the pixel driving circuit.

In one embodiment, the present application provides a display panel for implementing the display driving method in any of the above-mentioned embodiments.

It can be understood that, in this embodiment, the display panel can be, but is not limited to, an organic light-emitting diode (OLED) display panel, a micro-LED display panel, or a mini-LED display panel.

In one embodiment, the present application provides an electronic device, the electronic device is provided with at least a first refresh frequency and a second refresh frequency, and the first refresh frequency is greater than the second refresh frequency. The electronic device includes an IC chip for obtaining a target brightness of the display frame based on the first refresh frequency. The data configuration displayed at the second refresh frequency can be obtained according to the target brightness, and the data configuration in response to the second refresh frequency is performed.

In one embodiment, the electronic device may include, but is not limited to, the display panel in any of the foregoing embodiments, or be used to implement the driving method in any of the foregoing embodiments.

It can be understood that the electronic device provided in the present application provides a corresponding number of display pulses to the corresponding pixel driving circuit for different refresh frequencies in each display drive cycle. This can have same or similar display time when displayed at different refresh frequencies and further have same or similar display brightness. This reduces or eliminates brightness difference or the flicker phenomenon that occurs when the refresh frequencies are switched. Moreover, only the number of the display pulses is changed, there is no need to switch the GOA timing, and it will not cause changes in the writing time of the data signal.

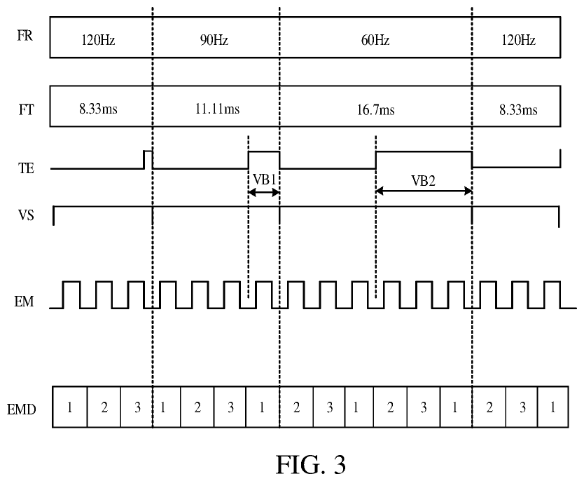

As shown in FIG. 3, in one embodiment, the display needs to support switching requirements of a refresh frequency of up to 120 Hz, a refresh frequency of 90 Hz, and a refresh frequency of 60 Hz.

Based on the above requirements, under the control of the vertical synchronization signal VS, it can be determined that at different refresh frequencies FR, the transmission speed of the data signal (data) output by the application (AP) terminal to the display runs at the highest refresh frequency of 120 Hz. The data transmission is synchronized by the data transmission synchronization signal TE inside the source driver (DIC). For example, when the data transmission synchronization signal TE is at a low level, it is the effective time for data writing and display, and when the data transmission synchronization signal TE is at a high level, it is the vertical blanking cycle (Blanking) of data writing and display. This is also known as the front-porch and back-porch of the display. As opposed to the highest refresh rate, the low refresh rate lengthens the display time of one frame by increasing the duration of the front porch and/or the back porch in the vertical blanking cycle to reduce the display refresh rate, and then switching between different refresh rates is realized based on the high refresh rate.

The display characteristics of current OLEDs determine that they are prone to serious unevenness (Mura) problems when displaying with low brightness and low grayscale. In these states, OLED displays usually need to adopt a pulse-width modulation (PWM) dimming method. That is, the dimming is performed by frequency modulation of the light-emitting control signal EM instead of direct current (DC) dimming (tributary dimming) to control the brightness of the display, where one light-emitting cycle of the light-emitting control signal EM corresponds to one display pulse.

Under this condition, in order to prevent the screen flicker problem, by controlling the light-emitting mechanism empirical mode decomposition (EMD), i.e., the number of the display pulses (Pluse) of the light-emitting control signal EM is adjusted to achieve same light-emitting time at different refresh frequencies, so as to prevent the screen flicker problem caused by different light-emitting brightness when frequencies are switched.

Under the condition of high display refresh rate, by increasing the duration of the front porch and/or the back porch in the vertical blanking cycle to reduce the frame frequency of display to achieve a low refresh rate. At the same time, insert a corresponding number of display pulses of the light-emitting control signal EM during the time of the front porch and/or the back porch in the increased vertical blanking cycle. This prevents the problem of screen flicker caused by different luminous brightness due to different display times when the refresh frequencies are switched.

Because the 90 Hz and 60 Hz refresh frequencies also need to be supported, the first refresh frequency is set to be F1, the second refresh frequency is set to be F2, the third refresh frequency is set to be F3, the initial number is set to be N, the first number to be increased is set to be M, and the second number to be increased is set to be Y, wherein N, M, and Y are all positive integers.

Based on the formula:

F1*N=F2*(N+M)=F3*(N+Y), wherein F1 is 120 Hz, F2 is 90 Hz, and F3 is 60 Hz, when the corresponding values are substituted into the formula, the following calculation formula is obtained: N=Y, and N=3M. Given that N, M, and Y are all positive integers, and that when the first number to be increased and the second number to be increased are the smallest positive integers, it can be obtained by calculation that the above-mentioned requirements can be met if M is 1, meaning the corresponding N is 3. That is, the initial number corresponding to this group of refresh frequencies is 3.

Based on the above, when the maximum refresh rate is 120 Hz, the duration FT for displaying one frame is 1/120 Hz=8.33 ms. When adopting a light-emitting mechanism EMD with an initial number of 3, the corresponding light-emitting cycle in the vertical effective display cycle is 3. That is, the number of Pluses is 3, and the light-emitting cycle duration is 2.77 ms. Based on this, the duration for the second refresh frequency to adopt 4 Pluses is 11.107 ms, which can be converted into a corresponding refresh frequency of 90 Hz. The duration for the third refresh frequency to adopt 6 Pluses is 16.67 ms, which can be converted into a corresponding refresh frequency of 60 Hz.

Therefore, the second refresh frequency of 90 Hz adopts light-emitting mechanism EMD of 4 Pluses. Correspondingly, the number of Pluses in its vertical effective display cycle is 3, and the number of Pluses in its vertical blanking cycle VB1 is 1. Correspondingly, the duration of the vertical blanking cycle VB1 is 2.77 ms.

The third refresh frequency of 60 Hz adopts a light-emitting mechanism EMD of 6 Pluses. Correspondingly, the number of Pluses in its vertical effective display cycle is 3, and the number of Pluses in its vertical blanking cycle VB2 is 3. Correspondingly, the duration of its vertical blanking cycle VB2 is 8.31 ms.

The above is not limited to this. If the maximum refresh frequency is 120 Hz, the light-emitting mechanism EMD of 6 Pluses can be used. The refresh frequency of 90 Hz can adopt a light-emitting mechanism EMD of 8 Pluses, and the refresh frequency of 60 Hz can adopt a light-emitting mechanism EMD of 12 Pluses. Therefore, for a refresh frequency of 120 Hz, a light-emitting mechanism EMD of 3L (i.e., a multiple of 3) Pluses can be used, for a refresh frequency of 90 Hz, a light-emitting mechanism EMD of 4L (i.e., a multiple of 4) Pluses can be used, and for a refresh frequency of 60 Hz, a light-emitting mechanism EMD of 6L (i.e., a multiple of 6) Pluses can be used.

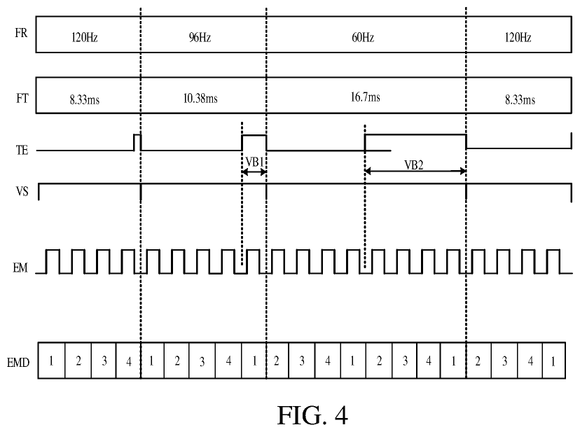

As shown in FIG. 4, in one embodiment, the display needs to support switching requirements of a maximum refresh frequency of 120 Hz, a refresh frequency of 96 Hz, and a refresh frequency of 60 Hz.

Based on the above requirements, under the control of the vertical synchronization signal VS, it can be determined that under different refresh frequencies FR, the transmission speed of the data signal (data) output by the application (AP) terminal to the display runs at the highest refresh frequency of 120 Hz. The data transmission is synchronized by the data transmission synchronization signal TE inside the source driver (DIC). For example, when the data transmission synchronization signal TE is at a low level, it is the effective time for data writing and display, and when the data transmission synchronization signal TE is at a high level, it is the vertical blanking cycle (Blanking) of data writing and display. This is also known as the front-porch and back-porch of the display. As opposed to the highest refresh rate, the low refresh rate lengthens the display time of one frame by increasing the duration of the front porch and/or the back porch in the vertical blanking cycle to reduce the display refresh rate, and then switching between different refresh frequencies is realized based on the high refresh rate.

The display characteristics of current OLED determine that it is prone to serious unevenness (Mura) problems when displaying under low brightness and low grayscale. In this state, the OLED display usually needs to adopt a pulse-width modulation (PWM) dimming method. That is, the dimming is performed by frequency modulation of the light-emitting control signal EM instead of direct current (DC) dimming (tributary dimming) to control the brightness of the display, where one light-emitting cycle of the light-emitting control signal EM corresponds to one display pulse.

Under this condition, in order to prevent the display flicker problem, by controlling the light-emitting mechanism EMD, i.e., the number of the display pulses (Pluse) of the light-emitting control signal EM is adjusted to achieve the same light-emitting time under different refresh frequencies, so as to prevent the flicker problem caused by different light-emitting brightness when the frequency is switched.

Under the condition of high display refresh rate, by increasing the duration of the front porch and/or the back porch in the vertical blanking cycle to reduce the frame frequency of display to achieve a low refresh rate. At the same time, insert a corresponding number of display pulses of the light-emitting control signal EM during the duration of the front porch and/or the back porch in the increased vertical blanking cycle. This prevents the problem of screen flicker caused by different luminous brightness due to different display times when the refresh frequency is switched.

Because the 96 Hz and 60 Hz refresh frequencies also need to be supported, the first refresh frequency is set to be F1, the second refresh frequency is set to be F2, the third refresh frequency is set to be F3, the initial number is set to be N, the first number to be increased is set to be M, and the second number to be increased is set to be Y, wherein N, M, and Y are all positive integers.

Based on the formula:

F1*N=F2*(N+M)=F3*(N+Y), wherein F1 is 120 Hz, F2 is 90 Hz, and F3 is 60 Hz. When the corresponding values are substituted into the formula, the following calculation formula can be obtained: N=Y, and N=4M. Given that N, M, and Y are all positive integers, and that when the first number to be increased and the second number to be increased are the smallest positive integers, it can be obtained by calculation that the above-mentioned requirements can be met if M is 1, meaning the corresponding N is 4. That is, the initial number corresponding to this group of refresh frequencies is 4.

Based on the above, when the maximum refresh rate is 120 Hz, the time FT for displaying one frame is 1/120 Hz=8.33 ms. When adopting a light-emitting mechanism EMD with an initial number of 4, the corresponding light-emitting cycle in the vertical effective display cycle is 4. That is, the number of Pluses is 4, and the light-emitting cycle duration is 2.08 ms. Based on this, the duration for the second refresh frequency of 5 Pluses is 10.417 ms, which can be converted into a corresponding refresh frequency of 96 Hz. The duration for the third refresh frequency of 8 Pluse is 16.7 ms, which can be converted into a corresponding refresh frequency of 60 Hz.

Therefore, the second refresh frequency of 96 Hz adopts a light-emitting mechanism EMD of 5 Pluses. Correspondingly, the number of Pluses in its vertical effective display cycle is 4, and the number of Pluses in its vertical blanking cycle VB1 is 1. Correspondingly, the duration of the vertical blanking cycle VB1 is 2.08 ms.

The third refresh frequency of 60 Hz adopts a light-emitting mechanism EMD of 8 Pluses. Correspondingly, the number of Pluses in its vertical effective display cycle is 4, and the number of Pluses in its vertical blanking cycle VB2 is 4. Correspondingly, the duration of its vertical blanking cycle VB2 is 8.32 ms.

The above is not limited to this, if the maximum refresh rate is 120 Hz, the light-emitting mechanism EMD of 8 Pluses can be used. The 96 Hz refresh frequency can adopt a light-emitting mechanism EMD of 10 Pluses, and the 60 Hz refresh frequency can adopt a light-emitting mechanism EMD of 16 Pluses. Therefore, for a refresh frequency of 120 Hz, a light-emitting mechanism EMD of 4L (i.e., a multiple of 4) Pluses can be used. For a refresh frequency of 96 Hz, a light-emitting mechanism EMD of 5L (i.e., a multiple of 5) Pluses can be used, and for a refresh frequency of 60 Hz, a light-emitting mechanism EMD of 8L (i.e., a multiple of 8) Pluses can be used. It can be understood that, for one of ordinary skill in the art, equivalent replacements or modifications can be made according to the technical solution of the present application and its inventive concept, and all these modifications or replacements shall fall within the protection scope of the claims of the present application.

What is claimed is:

1. A display panel, comprising:
a plurality of pixels;
a plurality of pixel driving circuits, wherein each of the plurality of pixel driving circuits is electrically connected to a corresponding one of the pixels;
a gate-on-array (GOA) circuit electrically connected to the plurality of pixel driving circuits and configured to provide the plurality of pixel driving circuits with a corresponding number of display pulses in each of display driving cycles; and
an IC chip electrically connected to the GOA circuit and configured to control the GOA circuit to switch the number of the display pulses output in the display driving cycles according to a frequency switching signal.

2. The display panel according to claim 1, wherein the display panel is at least provided with a first refresh frequency and a second refresh frequency, wherein the first refresh frequency is greater than the second refresh frequency;
the IC chip is configured to control the GOA circuit to increase the number of the display pulses output in the display driving cycles when the display panel is switched from the first refresh frequency to the second refresh frequency; or
the IC chip is configured to control the GOA circuit to reduce the number of the display pulses output in the display driving cycles when the display panel is switched from the second refresh frequency to the first refresh frequency.

3. The display panel according to claim 2, wherein each of the display driving cycles comprises an effective display period and an ineffective display period;
each of the plurality of pixel driving circuits is configured to drive the corresponding one of the pixels to display an image according to the display pulses received during the effective display period; and
the IC chip is configured to control the GOA circuit to provide the display pulses with a difference between a number of the display pulses during the effective display period of the display driving cycles corresponding to the first refresh frequency and a number of the display pulses provided during the effective display period of the display driving cycles corresponding to the second refresh frequency, wherein the difference is less than or equal to a preset threshold.

4. The display panel according to claim 3, wherein the IC chip is configured to control the GOA circuit to provide a same number of the display pulses during the effective display period of the display driving cycles corresponding to the first refresh frequency and during the effective display period of the display driving cycles corresponding to the second refresh frequency.

5. The display panel according to claim 4, wherein the IC chip is configured to control the GOA circuit to provide the display pulses with a number of the display pulses during the ineffective display period of the display driving cycles corresponding to the first refresh frequency to be greater than a number of the display pulses provided during the ineffective display period of the display driving cycles corresponding to the second refresh frequency.

6. The display panel according to claim 3, wherein the IC chip is configured to control the GOA circuit to provide a same number of the display pulses during the effective display period of the display driving cycles corresponding to the first refresh frequency and during the effective display period of the display driving cycles corresponding to the second refresh frequency according to a following formula: 1/F1*1/N1=1/F2*1/(N1+X1); wherein F1 is the first refresh frequency, F2 is the second refresh frequency, N1 is the number of the display pulses provided during the effective display period of the display driving cycles corresponding to the first refresh frequency, and X1 is a number of the display pulses provided in the ineffective display period of the display driving cycles corresponding to the second refresh frequency, and wherein N1 and X1 are both positive integers.

7. The display panel according to claim 2, further provided with a third refresh frequency, wherein the first refresh frequency is greater than the third refresh frequency, and the second refresh frequency is different from the third refresh frequency;
the IC chip is configured to control the GOA circuit to increase the number of the display pulses output in the display driving cycles when the display panel is switched from the first refresh frequency to the third refresh frequency; or
the IC chip is configured to control the GOA circuit to reduce the number of the display pulses output in the display driving cycles when the display panel is switched from the third refresh frequency to the first refresh frequency.

8. The display panel according to claim 7, wherein each of the display driving cycles comprises an effective display period and an ineffective display period;
wherein the IC chip is configured to control the GOA circuit to provide a same number of the display pulses during the effective display period of the display driving cycles corresponding to the first refresh frequency, during the effective display period of the display driving cycles corresponding to the second refresh frequency, and during effective display period of the display driving cycles corresponding to the third refresh frequency.

9. The display panel according to claim 8, wherein the IC chip is configured to control the GOA circuit to provide a same number of the display pulses during the effective display period of the display driving cycles corresponding to the first refresh frequency, during the effective display period of the display driving cycles corresponding to the second refresh frequency, and during the effective display period of the display driving cycles corresponding to the third refresh frequency, according to a following formula:
1/F1*1/N1=1/F2*1/(N1+X1)=1/F3*1/(N1+X2);
wherein F1 is the first refresh frequency, F2 is the second refresh frequency, F3 is the third refresh frequency, N1 is the number of the display pulses provided during the effective display period of the display driving cycles corresponding to the first refresh frequency, and X1 is a number of the display pulses provided in the ineffective display period of the display driving cycles corresponding to the second refresh frequency, and X2 is a number of the display pulses provided in the ineffective display period of the display driving cycles corresponding to the third refresh frequency, and wherein N1, X1, and X2 are all positive integers.

10. The display panel according to claim 4, wherein the effective display period is a vertical effective display cycle, and the ineffective display period is a vertical blanking cycle.

11. An electronic device, comprising the display panel according to claim 1.

12. The electronic device according to claim 11, wherein the display panel is at least provided with a first refresh frequency and a second refresh frequency; wherein the IC chip is configured to control the GOA circuit to increase the number of the display pulses output in the display driving cycles when the display panel is switched from the first refresh frequency to the second refresh frequency, or the IC chip is configured to control the GOA circuit to reduce the number of display pulses output in the display driving cycles when the display panel is switched from the second refresh frequency to the first refresh frequency.

13. The electronic device according to claim 12, wherein each of the display driving cycles comprises an effective display period and an ineffective display period; each of the plurality of pixel driving circuits is configured to drive the corresponding one of the pixels to display an image according to the display pulse received during the effective display period; and the IC chip is configured to control the GOA circuit to provide the display pulses with a difference between a number of the display pulses during the effective display period of the display driving cycles corresponding to the first refresh frequency and a number of the display pulses provided during the effective display period of the display driving cycles corresponding to the second refresh frequency, wherein the difference is less than or equal to a preset threshold.

14. The electronic device according to claim 13, wherein the IC chip is configured to control the GOA circuit to provide a same number of the display pulses during the effective display period of the display driving cycles corresponding to the first refresh frequency and during the effective display period of the display driving cycles corresponding to the second refresh frequency.

15. The electronic device according to claim 14, wherein the IC chip is configured to control the GOA circuit to provide the display pulses with a number of the display pulses during the ineffective display period of the display driving cycles corresponding to the first refresh frequency to be greater than a number of the display pulses provided during the ineffective display period of the display driving cycles corresponding to the second refresh frequency.

16. The electronic device according to claim 13, wherein the IC chip is configured to control the GOA circuit to provide a same number of the display pulses during the effective display period of the display driving cycles corresponding to the first refresh frequency and during the effective display period of the display driving cycles corresponding to the second refresh frequency according to a following formula:
1/F1*1/N1=1/F2*1/(N1+X1);
wherein F1 is the first refresh frequency, F2 is the second refresh frequency, N1 is the number of the display pulses provided during the effective display period of the display driving cycles corresponding to the first refresh frequency, and X1 is a number of the display pulses provided in the ineffective display period of the display driving cycles corresponding to the second refresh frequency, and wherein N1 and X1 are both positive integers.

17. The electronic device according to claim 12, further provided with a third refresh frequency, wherein the second refresh frequency is different from the third refresh frequency;
the IC chip is configured to control the GOA circuit to increase the number of the display pulses output in the display driving cycles when the display panel is switched from the first refresh frequency to the third refresh frequency; or
the IC chip is configured to control the GOA circuit to reduce the number of the display pulses output in the display driving cycles when the display panel is switched from the third refresh frequency to the first refresh frequency.

18. The electronic device according to claim 17, wherein each of the display driving cycles comprises an effective display period and an ineffective display period; wherein the IC chip is configured to control the GOA circuit to provide same number of the display pulses during the effective display period of display driving cycles corresponding to the first refresh frequency, during the effective display period of display driving cycles corresponding to the second refresh frequency, and during the effective display period of display driving cycles corresponding to the third refresh frequency.

19. The electronic device according to claim 18, wherein the IC chip is configured to control the GOA circuit to provide a same number of the display pulses during the effective display period of the display driving cycles corresponding to the first refresh frequency, during the effective display period of the display driving cycles corresponding to the second refresh frequency, and during the effective display period of the display driving cycles corresponding to the third refresh frequency, according to a following formula:
1/F1*1/N1=1/F2*1/(N1+X1)=1/F3*1/(N1+X2);
wherein F1 is the first refresh frequency, F2 is the second refresh frequency, F3 is the third refresh frequency, N1 is the number of the display pulses provided during the effective display period of the display driving cycles corresponding to the first refresh frequency, X1 is a number of the display pulses provided in the ineffective display period of the display driving cycles corresponding to the second refresh frequency, and X2 is a number of the display pulses provided in the ineffective display period of the display driving cycles corresponding to the third refresh frequency, and wherein N1, X1, and X2 are all positive integers.

20. The electronic device according to claim 14, wherein the effective display period is a vertical effective display cycle, and the ineffective display period is a vertical blanking cycle.
